(19) United States
(12) Patent Application Publication
(10) Pub. No.: US 2026/0048355 A1
(43) Pub. Date: Feb. 19, 2026

(54) AIR PURIFIER AND METHOD OF OPERATING THE SAME

(71) Applicant: COWAY Co., Ltd., Gongju-si (KR)

(72) Inventors: Tae Hyun KIM, Seoul (KR); Il CHU, Seoul (KR); Jin Min KIM, Seoul (KR)

(73) Assignee: COWAY Co., Ltd., Gongju-si (KR)

(21) Appl. No.: 19/293,113

(22) Filed: Aug. 7, 2025

(30) Foreign Application Priority Data
Aug. 14, 2024 (KR) 10-2024-0108747

(51) Int. Cl. B01D 46/46; B01D 46/00; B01D 46/44; B01D 46/62; G01N 15/0205; G01N 15/075

(52) U.S. Cl. CPC B01D 46/46; B01D 46/0038; B01D 46/0049; B01D 46/442; B01D 46/62; G01N 15/0205; G01N 15/075; B01D 2273/30

(57) ABSTRACT

In an air purifier and a method of operating the air purifier, the air purifier includes an intake port through which air is drawn in, a fan unit configured to provide a blowing force to allow the air to flow, a filter assembly configured to filter the air drawn in through the air intake port, an outlet port through which the air passing through the filter assembly is discharged, a dust sensor measuring a number concentration of a dust existing outside, and a controller configured to determine a particle distribution according to a dust particle size based on the number concentration and determining the type of a pollutant corresponding to the particle distribution.

This application claims priority under 35 U.S.C. § 119 to Korean Patent Application No. 10-2024-0108747, filed on Aug. 14, 2024, the disclosure of which is incorporated by reference herein in its entirety.

### BACKGROUND

### 1. Field of Disclosure

The present disclosure of invention relates to an air purifier and a method of operating the same, and more specifically the present disclosure of invention relates to an air purifier and a method of operating the same, capable of classifying a type of a pollutant based on a number concentration of a dust.

### 2. Description of Related Technology

Recently, due to an increase in a fine dust and an environmental pollution, an importance of an air purifier is increasing. Various activities, performed by users in a space where the air purifier is used, act as a pollutant in the space where the air purifier is used. Various pollution environments are formed according to various types of pollutants, and a need to efficiently control the air purifier according to the various pollution environments is emerging. However, an existing air purifier, regardless of the pollutant, uses a method of controlling an air volume of the air purifier according to a dust concentration while simply considering the dust concentration in a space.

Recently, a technology which determines a type of a pollutant and controls the air purifier according to the pollutant is required.

### SUMMARY

The present invention is developed to solve the above-mentioned problems of the related arts.

The present invention provides an air purifier and a method of operating the air purifier, capable of determining a distribution composition for each dust particle size, and determining a type of a pollutant and an activity corresponding to this.

In addition, the present invention also provides an air purifier and a method of operating the air purifier for applying a distance similarity determination algorithm which is given a weight, to give a distinguishable and significant difference in the sizes of each fine dust particle, and capable of accurately classifying a pollutant causing an air pollution among pollutant with similar distributions of fine dust particles based on this.

According to an example embodiment, the air purifier includes an intake port through which air is drawn in, a fan unit configured to provide a blowing force to allow the air to flow, a filter assembly configured to filter the air drawn in through the air intake port, an outlet port through which the air passing through the filter assembly is discharged, a dust sensor measuring a number concentration of a dust existing outside, and a controller configured to determine a particle distribution according to a dust particle size based on the number concentration and determining the type of a pollutant corresponding to the particle distribution.

In an example, the controller may include the particle distribution with a plurality of periods set corresponding to the dust particle size and a dust particle ratio included in each of the plurality of periods, and be configured to calculate a difference value between the dust particle ratio and a preset reference ratio for each pollutant for each of the plurality of periods and to determine a similarity based on a calculation value which is a sum of the difference value, to determine the type of the pollutant.

In an example, the controller may be configured to give a weight to the difference value in at least one period among the plurality of periods.

In an example, the controller may be configured to give the weight differently to the difference value for each of the plurality of periods, and the weight in a period, where the dust particle size is a smallest, may be a largest.

In an example, the controller may be configured to determine a first-priority pollutant and a second-priority pollutant in an order of decreasing the calculation value, to determine the first-priority pollutant as the type of the pollutant when a difference between the first-priority pollutant and the second-priority pollutant is greater than or equal to a threshold value, to give the weight differently to the difference value for each of the plurality of periods when the difference between the first-priority pollutant and the second-priority pollutant is less than the threshold value, and to increase the weight as the dust particle size is small.

In an example, the controller may be configured to configure the particle distribution as input training data, to configure the type of the pollutant as output training data, and to perform machine learning using an artificial neural network model based on a pair of the input training data and the output training data.

In an example, the controller may be configured to perform machine learning using an artificial neural network model based on labeled input training data consisting of the particle distribution and the type of the pollutant, respectively.

In an example, the controller may be configured to determine a discharge intensity of the air corresponding to at least one of the type of the pollutant and the particle distribution, and to control an operation of the fan unit corresponding to the discharge intensity.

In an example, the outlet port may be configured to adjust a discharge angle of the air, and the controller may be configured to determine the discharge angle corresponding to at least one of the type of the pollutant and the particle distribution, and to control the outlet port corresponding to the discharge angle.

In an example, the filter assembly may include a plurality of filters which perform each of a plurality of filtering functions, and the controller may be configured to select at least one filtering function to be processed among the plurality of filtering functions corresponding to at least one of the type of the pollutant and the particle distribution, and to selectively operate the plurality of filters or generate recommended filter information corresponding to the at least one filtering function.

In an example, the controller may be configured to determine an activity occurring in a space where the air purifier is placed based on at least one of the type of the pollutant and the particle distribution, to predict a predetermined area of the space where particles will be concentrated due to the activity, and to control a wind direction of the air such that the discharged air is directed toward the predetermined area.

In an example, the controller may be configured to adjust a measurement cycle of the dust sensor corresponding to at least one of the type of the pollutant and the particle distribution.

According to another example embodiment, a method of operating an air purifier includes measuring a number concentration of a dust existing outside by a dust sensor, determining a particle distribution according to a dust particle size based on the number concentration, determining a type of a pollutant corresponding to the particle distribution, filtering an air, which is drawn from outside, corresponding to the type of the pollutant by a filter assembly, and discharging the air passing through the filter assembly to the outside through an outlet port.

In an example, the particle distribution may be composed of a plurality of periods set corresponding to the dust particle size and a dust particle ratio included in each of the plurality of periods, and a difference value between the dust particle ratio and a preset reference ratio for each preset pollutant for each of the plurality of periods may be calculated, and a similarity may be determined based on a calculation value which is a sum of the difference value, such that the type of the pollutant may be determined.

In an example, a weight may be given to the difference value in at least one period among the plurality of periods.

In an example, the weight may be given differently to the difference value for each of the plurality of periods, and the weight in a period, where the dust particle size is a smallest, may be a largest.

In an example, a first-priority pollutant and a second-priority pollutant may be determined in an order of decreasing the calculation value, the first-priority pollutant may be determined as the type of the pollutant when a difference between the first-priority pollutant and the second-priority pollutant is greater than or equal to a threshold value, the weight may be given differently to the difference value for each of the plurality of periods when the difference between the first-priority pollutant and the second-priority pollutant is less than the threshold value, and the weight may be increased as the dust particle size is small.

In an example, the particle distribution may be configured as input training data, the type of the pollutant may be configured as output training data, and a learning may be performed by an artificial neural network model based on a pair of the training data and the output training data.

In an example, a learning may be performed by an artificial neural network model based on labeled input training data consisting of the particle distribution and the type of the pollutant, respectively.

In an example, based on at least one of the type of the pollutant and the particle distribution, an activity occurring in a space where the air purifier is placed may be determined, a predetermined area of the space where particles will be concentrated due to the activity may be predicted, and a wind direction of the air may be controlled such that the discharged air may be directed toward the predetermined area.

In an example, a measurement cycle of the dust sensor corresponding to at least one of the type of the pollutant and the particle distribution may be adjusted.

According to the present example embodiments, based on a number concentration of a dust, a distribution composition of the dust may be determined, and a type of a pollutant and activity may be determined correspondingly.

In addition, according to the present example embodiments, by analyzing a particle size and a ratio of dust, the type of the pollutant and the activity may be determined more accurately and in detail.

Furthermore, according to the present example embodiments, by applying a weighted distance similarity determination algorithm, a significant difference capable of be distinguished is given to each fine dust particle size, and based on this, pollutant with similar distribution of the fine dust particle may be accurately classified.

### BRIEF DESCRIPTION OF THE DRAWINGS

FIG. 1 is a perspective view of an exterior of an air purifier according to an embodiment of the present invention;

FIG. 2 is a block diagram illustrating a configuration of an air purifier according to an embodiment of the present invention;

FIG. 3A and FIG. 3B are diagrams for explaining a method of determining a type of a pollutant according to an embodiment of the present invention;

FIG. 4A is a table showing sensor data measured by case;

FIG. 4B is a table showing sensor data converted into percentage;

FIG. 4C is a result of comparing data of FIG. 4B with a reference ratio for each pollutant in FIG. 3A;

FIG. 4D shows a case where a weight is given for each dust particle size period;

FIG. 5A and FIG. 5B are graphs visualizing a particle size distribution for each pollutant according to an embodiment of the present invention;

FIG. 6 is a diagram for explaining an example of determining a type of a pollutant based on a graph visualized by an embodiment of the present invention;

FIG. 7 is a diagram showing an operation process of an air purifier according to an embodiment of the present invention;

FIG. 8 is a diagram showing an operation process of an air purifier according to another embodiment of the present invention;

FIG. 9A shows a case of performing a supervised learning;

FIG. 9B shows a case of performing an unsupervised learning;

FIG. 10 is a diagram for explaining a method of controlling a mode of an air purifier according to an embodiment of the present invention;

FIG. 11 is a diagram showing a detailed configuration of a filter assembly included in an air purifier according to the present invention; and

FIG. 12 is a diagram showing a computing device according to an embodiment of the present invention.

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention is described more fully hereinafter with reference to the accompanying drawings, in which embodiments of the invention are shown.

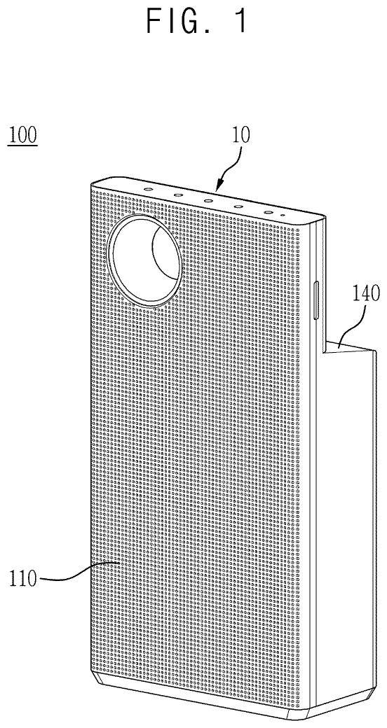

FIG. 1 is a perspective view of an exterior of an air purifier according to an embodiment of the present invention.

As shown in FIG. 1, an exterior of an air purifier 100 according to an embodiment of the present invention may be configured to include a main body 10, an inlet port 110, and an outlet port 140.

The main body 10 forms the exterior of the air purifier 100.

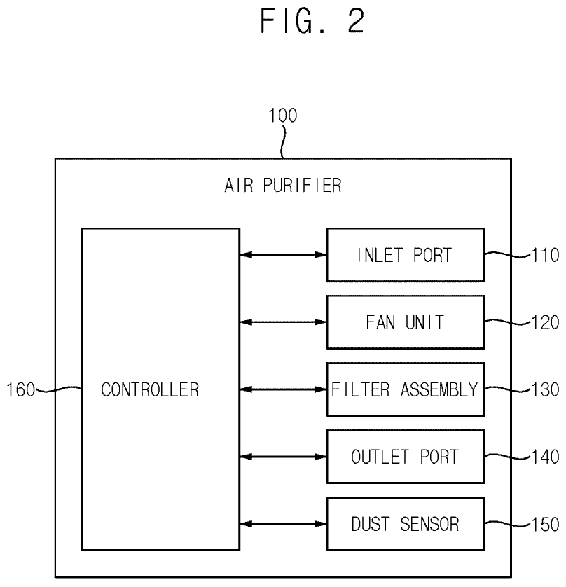

In a space formed in an interior of the main body 10, components necessary for an operation of the air purifier 100, specifically, a fan unit 120, a filter assembly 130, a dust sensor 150, and a control port 160, which will be described later in FIG. 2, may be stored. In addition, a motor (not shown) for driving the fan unit 120 may be further included, and a path for guiding the a flow of an air may be formed.

The inlet port 110 may be disposed on a front of the main body 10. The inlet port 110 may have multiple holes or slits formed on a surface to suck in an external air of the air purifier 100 in the interior.

The outlet port 140 may be disposed on a rear of the main body 10. The outlet port 140 may include a plurality of duct grills to discharge an internal air filtered in the air purifier 100 to the exterior.

In an embodiment, the inlet port 110 and the outlet port 140 may be disposed to correspond to each other. However, the present invention is not limited thereto, and an disposition, a position, a number, a structure, and an operation of the inlet port 110 and the outlet port 140 may be implemented in various ways according to the embodiment.

Although not shown in FIG. 1, the air purifier 100 according to an embodiment of the present invention may further include an air quality indicator (not shown). The air quality indicator (not shown) is implemented as a display panel or a light, and may intuitively display an indoor air pollution level in a real time. Accordingly, an user may intuitively recognize a clean state of the indoor air more easily.

FIG. 2 is a block diagram illustrating a configuration of an air purifier according to an embodiment of the present invention.

The air purifier 100 according to an embodiment of the present invention may determine a type of a pollutant using a particle distribution based on a number concentration of a dust, and may operate in a customized operation mode or operate a filter according to this.

The air purifier 100 according to an embodiment of the present invention may be configured to include an inlet port 110, a fan unit 120, a filter assembly 130, an outlet port 140, a dust sensor 150, and a control port 160.

An air is drawn into the inlet port 110. An outside air of the air purifier 100 may be drawn into an interior of the air purifier 100 through the inlet port 110.

The fan unit 120 may provide a blowing force to allow the air to flow.

The filter assembly 130 may filter the air which is drawn into the inlet port 110.

Specifically, when the air is drawn from an exterior to the interior of the air purifier 100, the filter assembly 130 may filter the dust included in the air or sterilize the air.

In an embodiment, the filter assembly 130 may be configured to include a plurality of filters (not shown). The plurality of filters (not shown) may perform corresponding to each of the plurality of filtering functions. The plurality of filters (not shown) may be independently disposed in different areas such that the filtering functions are spatially separated, or may be hierarchically disposed in a same area such that the filtering functions are temporally separated. In addition, the plurality of filters (not shown) may all operate or may selectively operate.

The plurality of filters (not shown) may be classified into an ultrafine particle pre-filter, an air matching filter, a deodorizing filter, an ultrafine dust collection filter, etc., according to a filtering target. In addition, the plurality of filters (not shown) may be classified into a pre-filter, an electrostatic filter using an electrostatic precipitation method, a fine dust collecting filter in a form of a non-woven fabric made of a polypropylene resin or a polyethylene resin, a granular activated carbon filter, etc., according to a filtering method.

In an embodiment, the filter assembly 130 may be disposed to correspond to at least one of the inlet port 110 and the outlet port 140.

The outlet port 140 may discharge the air which has passed through the filter assembly 130. An internal air filtered in the interior of the air purifier 100 may be discharged to the exterior of the air purifier 100 through the outlet port 140.

In an embodiment, the outlet port 140 may be configured to adjust an discharge angle of the air. For example, the outlet port 140 may include the plurality of duct grills configured to be rotatable, and at least one of an inclination and an angle of the plurality of duct grills may be controlled by the control port 160.

The dust sensor 150 may measure a number concentration of a dust existing outside.

Specifically, the dust sensor 150 may measure a number concentration (a number density, a number density) for each particle size. For example, the dust sensor 150 may measure how many dust particles of a certain size are included in a unit volume of an outside air.

Here, the dust sensor 150 is graded according to a detectable particle size. For example, a PM (Particulate Matter) 1.0 sensor may detect an ultrafine dust of up to 1.0 μm, a PM2.5 sensor may detect an ultrafine dust of up to 2.5 μm, and a PM10 sensor may detect a fine dust of up to 10.0 μm.

For example, the dust sensor 150 may measure a number concentration value for each particle size period such as 0.3 μm, 0.5 μm, 1.0 μm, 2.5 μm, 5.0 μm, and 10.0 μm.

Meanwhile, the dust sensor 150 may measure the number concentration of the dust in various ways. For example, the dust sensor 150 may measure the number concentration for each particle size using a laser light source.

The control port 160 may determine the particle distribution according to a dust particle size based on the number concentration, and determine the type of the pollutant according to the particle distribution.

In an embodiment, the control port 160 may determine a similarity based on a mathematical operation to determine the type of the pollutant. Specifically, the control port 160 may configure the particle distribution with a plurality of periods set corresponding to the dust particle size, and a dust particle ratio included in each of the plurality of periods. In this case, the control port 160 may calculate a difference value between the dust particle ratio and a preset reference ratio for each pollutant for each of the plurality of periods and judge a similarity based on a calculation value which is a sum of the difference value, to determine the type of the pollutant. For example, the control port 160 may compare the particle distribution with a reference ratio of each pollutant to obtain a plurality of calculation values, and determine a pollutant corresponding to a smallest calculation value among the plurality of calculation values as a most similar type of a pollutant.

In another embodiment, the control port 160 may determine the type of the pollutant based on an artificial intelligence learning. Specifically, the control port 160 may determine the type of the pollutant based on a supervised learning or an unsupervised learning. The supervised learning derives a function from training data consisting of an input value and a corresponding output value. When determining the type of the pollutant based on the supervised learning, the control port 160 may configure the particle distribution as input training data, configure the type of the pollutant as output training data, and perform learning by an artificial neural network model based on a pair of input training data and output training data. The unsupervised learning derives a function from training data consisting of only input value without an output value. When determining the type of pollutant based on the unsupervised learning, the control port 160 may perform machine learning using an artificial neural network model based on labeled input training data each consisting of the particle distribution and the type of the pollutant.

In another embodiment, the control port 160 may compare a shape of the particle distribution to determine the type of the pollutant. For example, the control port 160 may set a first shape corresponding to the particle distribution according to the dust particle size, set a second shape corresponding to a particle distribution for each reference pollutant, and compare a similarity between the first shape and the second shape based on a similarity determination algorithm to determine the type of the pollutant.

Meanwhile, in order to give a meaningful difference between fine dust particles, the control port 160 may give a weight in a calculation process. In this case, the control port 160 may give a weight in various ways according to an embodiment.

In an embodiment, the control port 160 may give a weight to a difference value in at least one period among the plurality of periods. Accordingly, dust particles, belonging to a period to which the weight is given, have a meaningful difference, such that the dust particles belonging to the corresponding period may be classified precisely and accurately.

In another embodiment, the control port 160 may give a different weight to a difference value for each of the plurality of periods, and set a weight to be a largest in a period with a smallest dust particle size. Accordingly, a difference value in the period with the smallest dust particle size may be most widely distributed, such that a fine dust belonging to the period may be classified precisely and accurately.

In another embodiment, the control port 160 may determine a first-priority pollutant and a second-priority pollutant in an order of decreasing the calculation value, determine the first-priority pollutant as the type of the pollutant when a difference between the first-priority pollutant and the second-priority pollutant is greater than or equal to a threshold value, give the weight differently to the difference value for each of the plurality of periods when the difference between the first-priority pollutant and the second-priority pollutant is less than the threshold value, and increase the weight as the dust particle size is small. Accordingly, dust particles, whose the particle distribution according to the dust particle size is similar within an error range, may be classified more precisely and accurately.

In addition, the control port 160 may control the air purifier 100 in various ways corresponding to at least one of the type of the pollutant and the particle distribution.

In an embodiment, the control port 160 may determine a discharge intensity of the air corresponding to at least one of the type of the pollutant and the particle distribution, and control an operation of the fan unit 120 corresponding to the discharge intensity.

In another embodiment, the control port 160 may determine a discharge angle of the air corresponding to at least one of the type of the pollutant and the particle distribution, and control the outlet port 140 corresponding to the discharge angle. For this, the outlet port 140 may be configured to adjust the discharge angle of the air.

In another embodiment, the control port 160 may select at least one filtering function to be processed among a plurality of filtering functions corresponding to at least one of the type of the pollutant and the particle distribution, and selectively operate the plurality of filters or generate recommended filter information corresponding to at least one of the filtering functions.

In another embodiment, the control port 160 may determine an activity occurring in a space where the air purifier 100 is placed based on at least one of the type of pollutant and the distribution of particles, predict a predetermined area of a space where particles will be concentrated due to the activity, and control a wind direction of the air such that a discharged air is directed toward the predetermined area.

In another embodiment, the control port 160 may adjust a measurement cycle of the dust sensor 150 corresponding to at least one of the type of the pollutant and the particle distribution.

Meanwhile, the control port 160 may be composed of at least one processor (not shown). In this case, at least one processor (not shown) may include at least one of a central processing unit (CPU), a graphic processing unit (GPU), and a neural processing unit (NPU), but is not limited to the examples of the processors described above.

In particular, the NPU is a processor specialized in an artificial intelligence operation using an artificial neural network, and each layer which constitutes the artificial neural network may be configured with hardware (e.g., a silicon). In this case, the NPU is designed specifically according to a company's a requirement, so it has less freedom than the CPU or the GPU, but it may efficiently process the artificial intelligence operations which the company requires. Meanwhile, the NPU may be implemented in various forms, such as a tensor processing unit (TPU), an intelligence processing unit (IPU), and a vision processing unit (VPU).

In addition, the processor (not shown) may be implemented as a system on chip (SoC). In this case, in addition to the processor (not shown), the SoC may further include a network interface, such as a memory (not shown), a bus for a data communication between the processor (not shown) and the memory (not shown).

When a plurality of processors are included in the SoC, the control port 160 may perform a calculation related to an artificial intelligence (e.g., an operation related to a learning or an inference of an artificial intelligence model) using some of the plurality of processors. For example, the control port 160 may perform an operation related to an artificial intelligence using at least one of a GPU, an NPU, a VPU, a TPU, and a hardware accelerator specialized in an artificial intelligence operation, such as a convolution operation and a matrix multiplication operation, among the plurality of processors. However, this is merely an example, and it is of course possible to process an operation related to an artificial intelligence using a general-purpose processor, such as a CPU.

The control port 160 may control to process input data according to a predefined control algorithm, an operation rule, or an artificial intelligence model stored in a memory (not shown). A predefined operation rule or the artificial intelligence model may be generated through a learning.

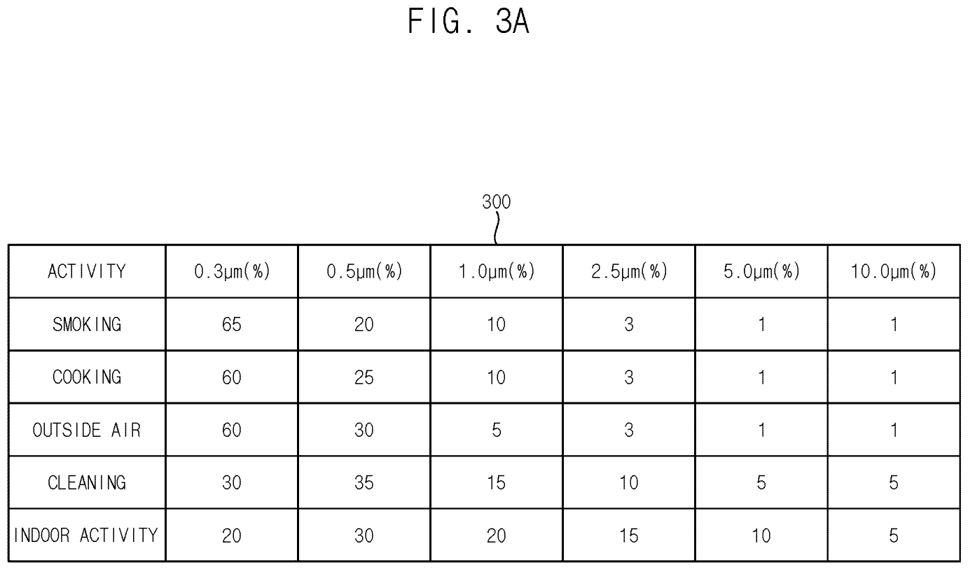

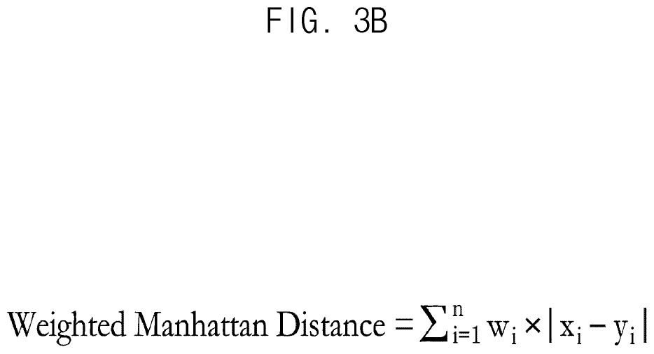

FIG. 3A and FIG. 3B are diagrams for explaining a method of determining a type of a pollutant according to an embodiment of the present invention.

In an embodiment of the present invention, the type of the pollutant may be determined by determining a similarity based on a mathematical operation. Specifically, the number concentration of the dust contained in the outside air is measured, and the particle distribution is configured based on this. The particle distribution is composed of the plurality of periods set corresponding to the dust particle size, and the dust particle ratio included in each of the plurality of periods. In this case, the type of the pollutant may be determined by calculating the difference value between the dust particle ratio and the predefined reference ratio for each pollutant for each of the plurality of periods, and determining the similarity based on the calculation value which is the sum of the difference value.

Specifically, FIG. 3A is a table 300 showing a reference ratio for each preset pollutant. As shown, the reference ratio for each preset pollutant is composed of the plurality of periods and the dust particle ratio included in each of the plurality of periods, similar to the particle distribution.

Here, the plurality of periods may be set to include values within a predetermined range based on a representative value labeled in each period. For example, in FIG. 3A, the representative value labeled in each of the plurality of periods is 0.3 μm, 0.5 μm, 1.0 μm, 2.5 μm, 5.0 μm, and 10.0 μm. In this case, the plurality of periods may be configured as periods with dust particle sizes of 0.3 μm or less (0.3 μm period), 0.3 μm or more to 0.5 μm or less (0.5 μm period), 0.5 μm or more to 1.0 μm or less (1.0 μm period), 1.0 μm or more to 2.5 μm or less (2.5 μm period), 2.5 μm or more to 5.0 μm or less (5.0 μm period), and 5.0 μm or more to 10.0 μm or less (10.0 μm period) corresponding to the labeled representative value.

In an embodiment, the labeled representative value of each of the plurality of periods may be set corresponding to a grade of the dust sensor 150. For example, 1.0 μm, 2.5 μm, and 10.0 μm may be set as the representative value corresponding to the PM1.0 sensor, the PM2.5 sensor, and the PM10 sensor.

In an embodiment, the type of the pollutant may be set corresponding to an activity performed in an indoor space. For example, it may be set as smoking, cooking, outside air (i.e., an outside air inflow by a ventilation), cleaning, indoor activity, etc.

The dust particle ratio included in each of the plurality of periods is set for each type of the pollutant. Here, the dust particle ratio may be set based on an actual value measured in a standard environment. For example, as shown in FIG. 3A, in a case of the smoking, a ratio of the fine dust particle in the air is composed of 65% in the 0.3 μm period, 20% in the 0.5 μm period, 10% in the 1.0 μm period, 3% in the 2.5 μm period, 1% in the 5.0 μm period, and 1% in the 10.0 μm period.

FIG. 3B is a mathematical formula for determining a similarity. According to this embodiment, the type of the pollutant may be determined by using a pollutant classification algorithm based on a particle distribution similarity. In this case, in order to determine the particle distribution similarity by considering a plurality of parameters (i.e., a plurality of periods) and each parameter value (i.e., a dust particle ratio), the pollutant classification algorithm which applies a concept of a K-Nearest Neighbor method was created.

The K-Nearest Neighbor method (KNN) is used to predict a label (class) of a new data point or to predict a continuous value based on a nearest neighbor (a data point) in a given dataset. In other words, the K-Nearest Neighbor method (KNN) is a machine learning algorithm which performs a decision-making such as a classification and a regression on new data based on a similarity of a data.

According to the K-Nearest Neighbor method, a distance between the new data point and each data point in a given dataset is calculated. In general, this distance measurement may use an Euclidean distance or a Manhattan distance. Based on the calculated distance, k closest neighbors are found. Classes of the k neighbors are checked, and the class of the new data point is predicted through a preset operation method (e.g., arithmetic mean, etc.).

Therefore, the Manhattan distance algorithm of the K-nearest neighbor method was applied inductively to generate a pollutant classification algorithm. According to this embodiment, the type of the pollutant may be determined by calculating the difference value between the dust particle ratio and the preset reference ratio for each pollutant for each of the plurality of periods and judge the similarity based on a calculation value which is the sum of the difference value, to determine the type of the pollutant.

According to the embodiment, a distance similarity may be calculated by giving the weight according to the dust particle size. According to an example, the weight may be given inversely proportional to the dust particle size. According to another example, a basic weight may be set to 1 for each particle size, and the weight may be set to 1.1 for the fine dust with a small particle size to additionally give a weight. By doing this, the fine dust with the small particle size may be mainly reflected, and the fine dust may be classified more subtly.

In general, since a large-particle dust falls to a floor or is easily filtered out, it is much more important for the air purifier 100 to filter a small-particle fine dust. In addition, most of the type of the pollutant is classified by the small-particle fine dust, but it is difficult to precisely classify the fine dust. Furthermore, as a risk of the fine dust has recently increased, it has become important to find the pollutant mainly composed of the fine dust. Therefore, by giving the weight to the small-particle fine dust, the pollutant may be judged differently based on a ratio and a composition of a small-particle size.

Referring to FIG. 3B, a mathematical formula generated by using the Manhattan distance method and giving the weight is shown. Here, i is an interval, Wᵢ is a weight given to an i period, Xᵢ is a dust particle ratio belonging to the i period, and Yᵢ is a reference ratio for each pollutant belonging to the i period. In this case, the Manhattan distance weighted by the particle size is calculated by the mathematical formula of FIG. 3B, and a pollutant and an activity with a closest distance may be determined.

Hereinafter, an actual computation process according to FIG. 3A and FIG. 3B will be described as an example. It is assumed that concentrations of 0.3 μm (micrometer) to 10.0 μm (micrometer) in recently measured 1-minute sensor data are 63, 23, 8, 2, 0, and 0, respectively. That is, actual measured sensor data are 0.3 μm (%)=63, 0.5 μm (%)=23, 1.0 μm (%)=8, 2.5 μm (%)=2, 5.0 μm (%)=0, and 10.0 μm (%)=0.

In order to determine which of the reference activities (smoking, cooking, outside air, cleaning, and indoor activities) of FIG. 3A the sensor data is similar to (i.e., close to), a distance between a measured sensor data value and each reference activity value is calculated using the mathematical formula shown in FIG. 3B.

In the mathematical formula of FIG. 3B, periods of the actual measured sensor data are reflected as follows.

$$Weighted Manhattan Distance = {W}_{0.3} \times \vert {X}_{0.3} - {Y}_{0.3} \vert + {W}_{0.5} \times \vert {X}_{0.5} - {Y}_{0.5} \vert + {W}_{1.} \times \vert {X}_{1.} - {Y}_{1.} \vert + {W}_{2.5} \times \vert {X}_{2.5} - {Y}_{2.5} \vert + {W}_{5.} \times \vert {X}_{5.0} - {Y}_{5.} \vert + {W}_{10.} \times \vert {X}_{10.} - {Y}_{10.} \vert$$

Here, it is assumed that a weight of 1.1 is given to W_{0.3} and a weight of 1.0 is given to W_{0.5} to W_{10.0}, respectively, by adding 10% to the weight for the small particle size.

When calculating a distance from the smoking, Weighted Manhattan

$${Distance}_{smoking} = 1 \text{.1} \times \vert 63 - 65 \vert + 1. \times \vert 23 - 20 \vert + 1. \times \vert 8 - 10 \vert + 1. \times \vert 2 - 3 \vert + 1. \times \vert 0 - 1 \vert + 1. \times \vert 0 - 1 \vert = 10.2 .$$

When calculating a distance from the cooking, Weighted Manhattan

$${Distance}_{cooking} = 1 \text{.1} \times \vert 63 - 60 \vert + 1. \times \vert 23 - 25 \vert + 1. \times \vert 8 - 10 \vert + 1. \times \vert 2 - 3 \vert + 1. \times \vert 0 - 1 \vert + 1. \times \vert 0 - 1 \vert = 10.3 .$$

When calculating a distance from the outside air, Weighted Manhattan

$${Distance}_{external air} = 1 \text{.1} \times \vert 63 - 60 \vert + 1. \times \vert 23 - 30 \vert + 1. \times \vert 8 - 5 \vert + 1. \times \vert 2 - 3 \vert + 1. \times \vert 0 - 1 \vert + 1. \times \vert 0 - 1 \vert = 16.3 .$$

When calculating a distance from the cleaning, Weighted Manhattan

$${Distance}_{cleaning} = 1 \text{.1} \times \vert 63 - 30 \vert + 1. \times \vert 23 - 35 \vert + 1. \times \vert 8 - 15 \vert + 1. \times \vert 2 - 10 \vert + 1. \times \vert 0 - 5 \vert + 1. \times \vert 0 - 5 \vert = 73.3 .$$

When calculating a distance from the indoor activity, Weighted Manhattan

$${Distance}_{indoor activity} = 1.1 \times \vert 63 - 20 \vert + 1. \times \vert 23 - 30 \vert + 1. \times \vert 8 - 20 \vert + 1. \times \vert 2 - 15 \vert + 1. \times \vert 0 - 10 \vert + 1. \times \vert 0 - 5 \vert = 94.3 .$$

Therefore, results of calculating the distance for each activity are as follows.

The smoking: Weighted Manhattan Distance_{smoking}=10.2

The cooking: Weighted Manhattan Distance_{cooking}=10.3

The outdoor Air: Weighted Manhattan Distance_{external air}=16.3

The cleaning: Weighted Manhattan Distance_{cleaning}=73.3

The indoor Activity: Weighted Manhattan Distance_{indoor activity}=94.3

As such, the Manhattan distance weighted for each activity is calculated, and the one with a smallest value is determined to correspond to the smoking.

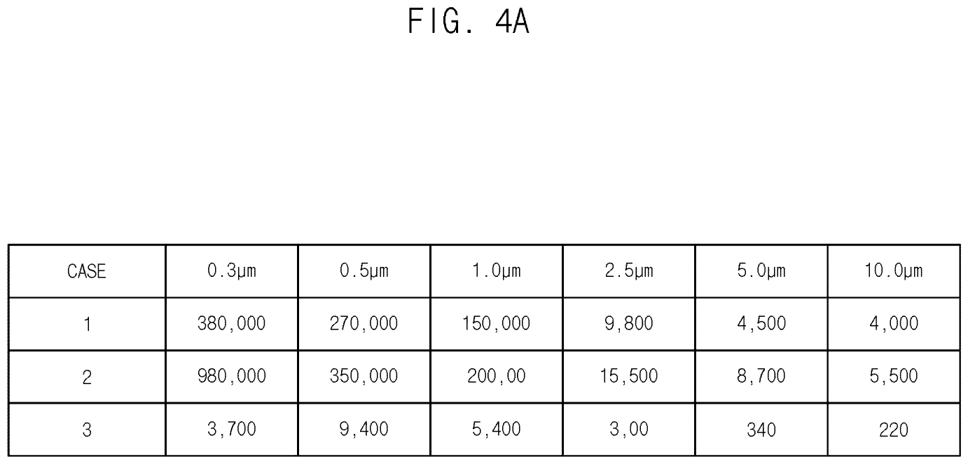

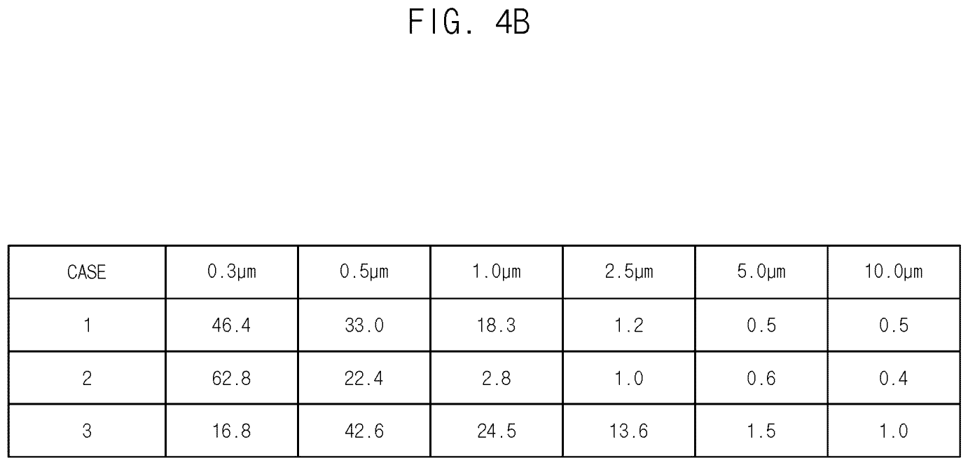

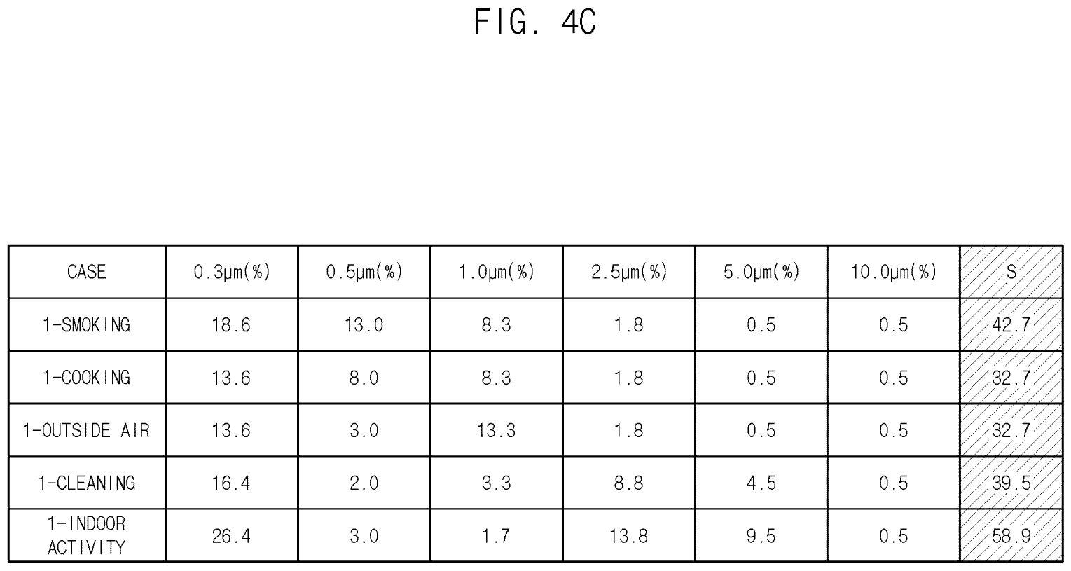

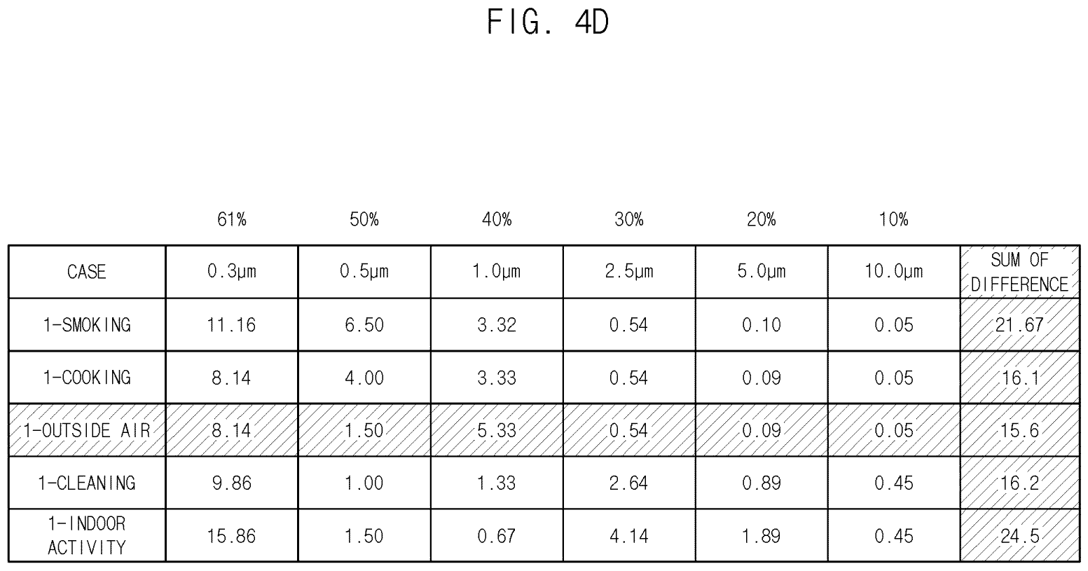

FIGS. 4A to 4D are diagrams for explaining an example of a calculation process for determining a type of a pollutant according to an embodiment of the present invention.

Specifically, FIG. 4A is a table showing sensor data measured by case. The sensor data may be generated based on the number concentration of the dust measured by the dust sensor. Based on the number concentration of the dust, a number of a dust particle is measured for each dust particle size period. For example, in FIG. 4A, in a case of Case 1, a 0.3 μm period is measured as 380,000, a 0.5 μm period as 270,000, a 1.0 μm period as 150,000, a 2.5 μm period as 9,800, a 5.0 μm period as 4,500, and a 10.0 μm period as 4,000.

FIG. 4B is a table showing sensor data converted into percentage. The dust particle ratio for each dust particle size period may be converted into the percentage. In this case, the dust particle ratio in the dust particle size period may be calculated by dividing a number of dust particles in the dust particle size period by a total number of the dust particles in an entire range. For example, in FIG. 4B, for Case 1, the 0.3 μm period is calculated as 46.4% (380,000 units/818,300 units×100), the 0.5 μm period is calculated as 33.0% (270,000 units/818,300 units×100), the 1.0 μm period is calculated as 18.3% (150,000 units/818,300 units×100), the 2.5 μm period is calculated as 1.2% (9,800 units/818,300 units×100), the 5.0 μm period is calculated as 0.5% (4,500 units/818,300 units×100), and the 10.0 μm period is calculated as 0.5% (4,000 units/818,300 units×100).

FIG. 4C is a result of comparing data of FIG. 4B with a reference ratio for each pollutant in FIG. 3A.

Specifically, a difference value between data of Case 1 of FIG. 4B and a reference ratio for each pollutant in FIG. 3A was calculated, and a calculation value S was calculated by adding up each difference value.

When calculating a difference value between the data of Case 1 and a reference ratio of the smoking in FIG. 3A, the 0.3 μm period is 18.6, the 0.5 μm period is 13.0, the 1.0 μm period is 8.3, the 2.5 μm period is 1.8, the 5.0 μm period is 0.5, and the 10.0 μm period is 0.5, and the calculation value S by adding up each difference value is 42.7.

When calculating a difference value between the data of Case 1 and the reference ratio of the cooking in FIG. 3A, the 0.3 μm period is 13.6, the 0.5 μm period is 8.0, the 1.0 μm period is 8.3, the 2.5 μm period is 1.8, the 5.0 μm period is 0.5, and the 10.0 μm period is 0.5, and the calculation value S by adding up each difference value is 32.7.

When calculating a difference value between the data of Case 1 and the reference ratio of the outside air in FIG. 3A, the 0.3 μm period is 13.6, the 0.5 μm period is 3.0, the 1.0 μm period is 13.3, the 2.5 μm period is 1.8, the 5.0 μm period is 0.5, and the 10.0 μm period is 0.5, and the calculation value S by adding up each difference value is 32.7.

When calculating a difference between the data of Case 1 and the reference ratio of the cleaning of FIG. 3A, the 0.3 μm period is 16.4, the 0.5 μm period is 2.0, the 1.0 μm period is 3.3, the 2.5 μm period is 8.8, the 5.0 μm period is 4.5, and the 10.0 μm period is 4.5, and the calculation value S by adding up each difference value is 39.5.

When calculating a difference between the data of Case 1 and the reference ratio of the indoor activity in FIG. 3A, the 0.3 μm period is 26.4, the 0.5 μm period is 3.0, the 1.0 μm period is 1.7, the 2.5 μm period is 13.8, the 5.0 μm period is 9.5, and the 10.0 μm period is 4.5, and the calculation value S by adding up each difference value is 58.9.

Referring to this, it may be seen that the calculation value S when compared to the cooking and the calculation value S when compared to outside air are each 32.7, which is a same. In other words, since the similarity is determined by adding up the difference values between the ratio for each particle size and the reference ratio for each pollutant, even if a distribution of a fine dust particle size itself is configured differently, when the combined result values are the same, there may be cases where similar pollutants cannot be accurately distinguished.

FIG. 4D shows a case where a weight is given for each dust particle size period. In order to solve the problem described in FIG. 4C, the weight may be given to the dust particle size. In an example, the weight may be given to the difference value in at least one period among the plurality of periods corresponding to the dust particle size. In another example, the weight may be given differently to the difference value in the plurality of periods corresponding to the dust particle size, but a largest weight may be given to a period with a smallest dust particle size.

Referring to FIG. 4D, a weight of 60% is given to the 0.3 μm period, a weight of 50% is given to the 0.5 μm period, a weight of 40% is given to the 1.0 μm period, a weight of 30% is given to the 2.5 μm period, a weight of 20% is given to the 5.0 μm period, and a weight of 10% is given to the 10.0 μm period.

In this case, a calculation value, which is a sum of each difference value, is calculated as 1−Smoking 21.67, 1−cooking 16.1, 1−outdoor air 15.6, 1−cleaning 16.2, and 1−indoor activity 24.5. Accordingly, 1−cooking and 1−outdoor air, which were calculated with a same calculation value in FIG. 4C and could not be distinguished, are distinguished. In addition, among the 1−cooking and 1−outside air which were calculated with a same calculation value and could not specify a smallest value, the 1−outside air with a smallest value may be specified, and thus an activity with a greatest similarity may be specified.

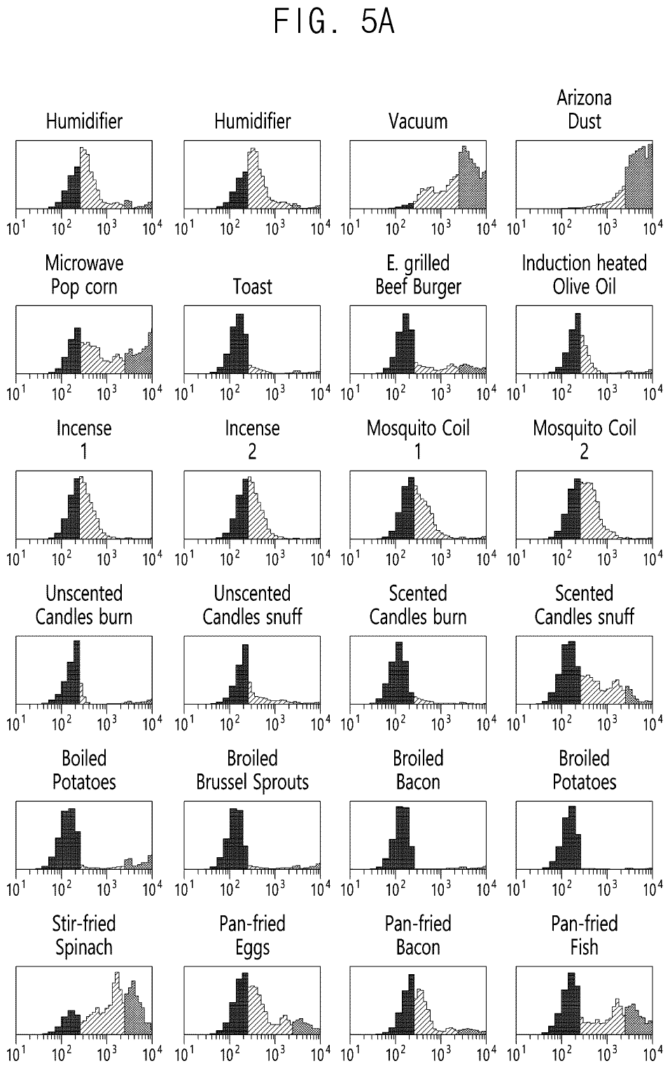

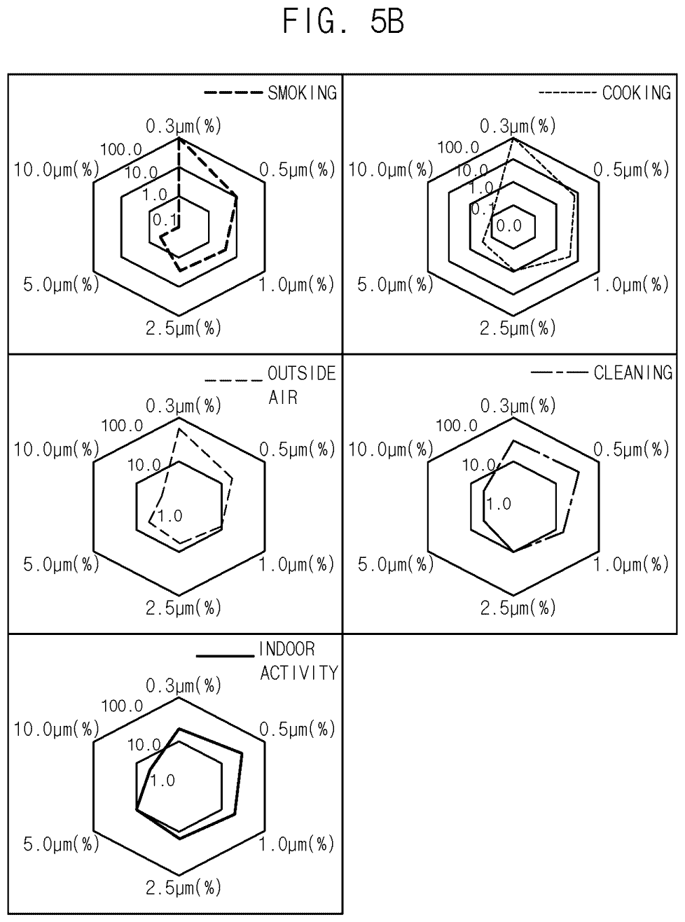

FIG. 5A and FIG. 5B are graphs visualizing a particle size distribution for each pollutant according to an embodiment of the present invention.

The type of the pollutant may be determined by comparing the shape of the particle distribution. Specifically, a graph visualizing a particle size distribution for each preset activity is constructed, and a shape of the graph is compared to calculate a similarity distance, thereby calculating and inferring an closest pollutant or activity. According to an embodiment, a first type is set corresponding to the particle distribution, a second type is set corresponding to the particle distribution for each pollutant, and the type of the pollutant may be determined by comparing a similarity of the first type and the second type based on a similarity determination algorithm.

FIG. 5A is a case where a reference ratio for each preset pollutant is visualized in a form of a bar graph. When the particle distribution according to the dust particle size is obtained based on the number concentration of the dust, the particle distribution may be configured in a form similar to a bar graph of FIG. 5A. In this case, a similarity distance between the bar graph configured corresponding to the particle distribution and the bar graph of FIG. 5A may be calculated. According to an embodiment, a method of calculating the similarity distance may be set in various ways. For example, a bar graph with a closest distance may be determined by comparing heights between corresponding bars, comparing a line connecting center points of the bars, or comparing areas of the bars.

In FIG. 5A, even if an type of the activity is different, if they belong to a same broad category, the particle distribution according to the dust particle size is roughly similar. For example, an activity of burning an incense (Incense 1, Incense 2) and an activity of burning a mosquito coil (Mosquito Coil 1, Mosquito Coil 2) belong to a category of burning the incense in a broad category, and thus exhibit similar particle distributions. Therefore, if particle distributions divided by the dust particle size and the dust particle ratio are not compared, the activities cannot be distinguished.

In the embodiments of the present invention, a similarity distance between a bar graph visualized corresponding to the dust particle distribution and a bar graph visualized corresponding to the reference ratio for each preset pollutant is calculated. By comparing shapes of two bar graphs, the type of pollutant or the activity may be distinguished more specifically and easily.

FIG. 5B is a case where a reference ratio for each preset pollutant is visualized in a form of a radial graph. The particle distribution according to the dust particle size may be configured in a form similar to a radial graph of FIG. 5B. In this case, a similarity distance between a radial graph configured corresponding to the particle distribution and a radial graph of FIG. 5B may be calculated. According to an embodiment, the method of calculating the similarity distance may be set in various ways. For example, by comparing positions of vertices on the radial graph, comparing areas where the vertices intersect, comparing a line connecting the vertices, or comparing an area formed by the radial graph, a radial graph with a closest distance may be determined.

In FIG. 5B, cleaning and indoor activities have similar approximate shapes of radial graphs. However, by comparing a slope of a line corresponding to the 5.0 μm period and the 10.0 μm period and an area where the line intersects, the two activities may be accurately distinguished.

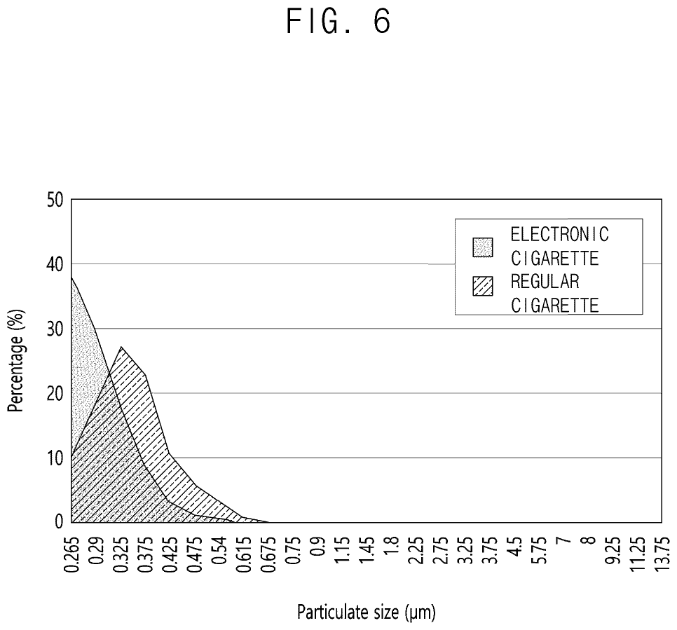

FIG. 6 is a diagram for explaining an example of determining a type of a pollutant based on a graph visualized by an embodiment of the present invention.

As shown in FIG. 6, both an electronic cigarette and a regular cigarette mainly generate fine dust particles of 0.675 micrometers or less when smoking. In this case, by comparing a similarity distance between graphs based on the dust particle size (Particulate size) and the dust particle ratio (Percentage) which make up each graph, it is possible to distinguish whether the type of the pollutant is the electronic cigarette or the regular cigarette.

In addition, when comparing a similarity distance between graphs by giving the weight to the dust particle size, dust particles which are to be classified may be classified in detail.

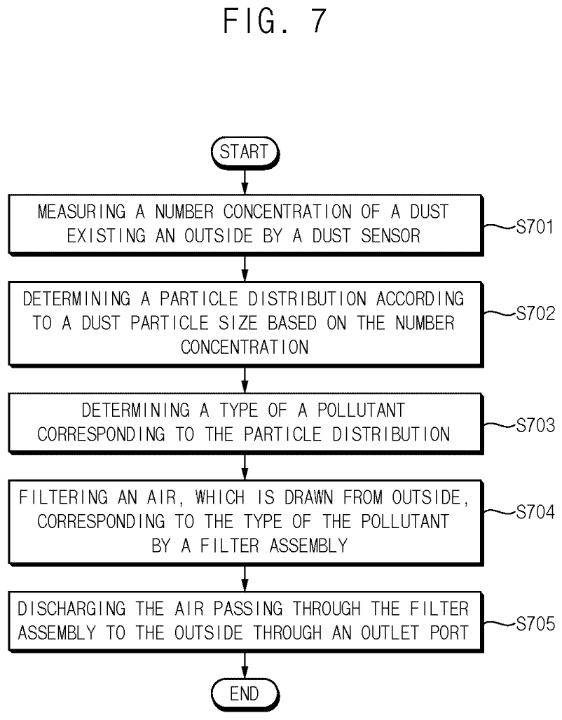

FIG. 7 is a diagram showing an operation process of an air purifier according to an embodiment of the present invention.

When an operation of the air purifier 100 starts, the dust sensor 150 measures the number concentration of the dust existing the outside (step S701).

Specifically, the dust sensor 150 may measure the number concentration for each particle size. For example, the dust sensor 150 may measure how many dust particles of a certain size are included in a unit volume of the outside air. For example, the dust sensor 150 may measure a number concentration value for each particle size period such as 0.3 μm, 0.5 μm, 1.0 μm, 2.5 μm, 5.0 μm, 10.0 μm, etc.

Based on the number concentration, the particle distribution according to the dust particle size is determined (step S702).

Specifically, the control port 160 may configure the particle distribution according to the dust particle size with the plurality of periods set corresponding to the dust particle size and the dust particle ratio included in each of the plurality of periods.

The type of the pollutant is determined corresponding to the particle distribution (step S703).

The control port 160 may determine the type of the pollutant based on various embodiments.

According to an embodiment, the type of the pollutant may be determined by determining the similarity by the mathematical formula. In this case, the control port 160 may calculate the difference value between the dust particle ratio and the preset reference ratio for each pollutant for each of the plurality of periods and judge the similarity based on the calculation value which is the sum of the difference value, to determine the type of the pollutant.

According to another embodiment, the control port 160 may determine the type of the pollutant by the artificial intelligence learning. Specifically, the control port 160 may determine the type of the pollutant by the supervised learning or the unsupervised learning.

According to another embodiment, the control port 160 may determine the type of pollutant by comparing the shape of the particle distribution. For example, the graph may be set corresponding to the particle distribution according to the dust particle size, and the type of the pollutant may be determined by comparing the shape of the graph.

In addition, in order to accurately classify the type of the pollutant, the control port 160 may give the weight according to various embodiments in the calculation process. According to an example, the weights may be given to the difference value in at least one period among the plurality of periods. According to another example, the weight may be given to the difference value differently for each of the plurality of periods, but the weight may be given to the period with the smallest dust particle size to be the largest.

The air which is drawn from the outside is filtered by the filter assembly corresponding to the type of the pollutant (step S704).

In an embodiment, the filter assembly 130 may be composed of a plurality of filters. In this case, the control port 160 may selectively operate the plurality of filters corresponding to the type of the pollutant or provide the recommendation filter information.

The air passing through the filter assembly is discharged to the outside through the outlet port (step S705).

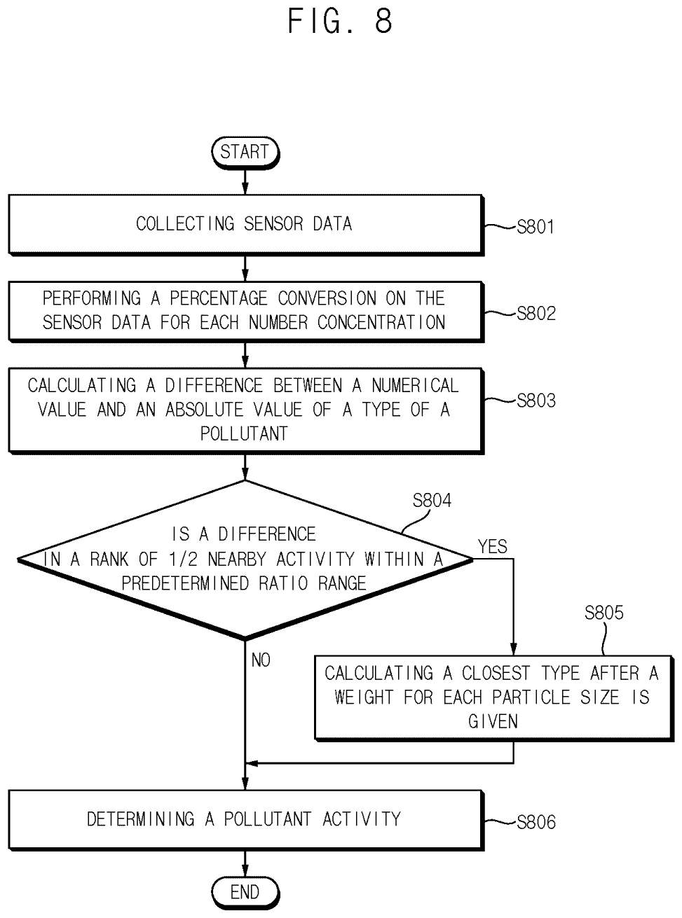

FIG. 8 is a diagram showing an operation process of an air purifier according to another embodiment of the present invention.

When the operation of the air purifier 100 starts, the sensor data is collected (step S801).

Specifically, number concentration data measured by the dust sensor 150 is collected. In an example, the number concentration data may be classified into the plurality of periods. For example, the number concentration data may be classified into 0.3 μm period, 0.5 μm period, 1.0 μm period, 2.5 μm period, 5.0 μm period, and 10.0 μm period, but the present invention is not limited thereto. The plurality of periods may be set in various ways according to a detectable particle size based on the grade of the dust sensor 150.

A percentage conversion is performed on the sensor data for each number concentration (step S802).

A ratio of a particle belonging to each period among an entire number concentration data is converted. For example, the ratio of the particle belonging to each of the 0.3 μm period, 0.5 μm period, 1.0 μm period, 2.5 μm period, 5.0 μm period, and 10.0 μm period is converted into a percentage.

A difference between a numerical value and an absolute value of the type of the pollutant is calculated (step S803).

A difference with preset pollutant/activity-specific particle size distribution reference ratio is calculated. In other words, an absolute value of a particle size reference ratio and a measurement particle ratio according to the pollutant/activity is calculated. In this case, since it is to determine a distance similarity, the absolute value is calculated.

It is determined whether a difference in a rank of ½ nearby activity is within a predetermined ratio range (step S804).

Specifically, 1st and 2nd pollutants are selected in an order of a smallest calculation value, and the ranks of the two activities which are determined to have a closest distance similarity are determined. In this case, it is determined whether a difference between the closest 1st and 2nd activities is within 5%.

If the difference between the 1st and 2nd activities is within 5% (step S804—Yes), a closest type is calculated after a weight for each particle size is given (step S805).

When the difference is within 5%, it may be considered a result value within an error range. Therefore, a closest activity may be derived by utilizing a calculation method which give a Manhattan weight. For example, when a difference between the first-priority pollutant and the second-priority pollutant is less than a threshold value, the weight may be applied differently to a difference value for each period, and the weight may be increased as the dust particle size becomes smaller.

On the other hand, when the difference between the first-priority activity and the second-priority activity is not within 5% (step S804—No), no weight for each particle size is applied.

When the difference is not within 5%, it may be considered a result value which falls outside the error range. Therefore, the closest activity is derived by calculating an absolute difference without the weight. For example, when the difference between the first-priority pollutant and the second-priority pollutant is greater than the threshold value, the first-priority pollutant may be determined as the type of the pollutant. A pollutant activity is determined (step S806).

A nearest activity is determined as a main pollutant.

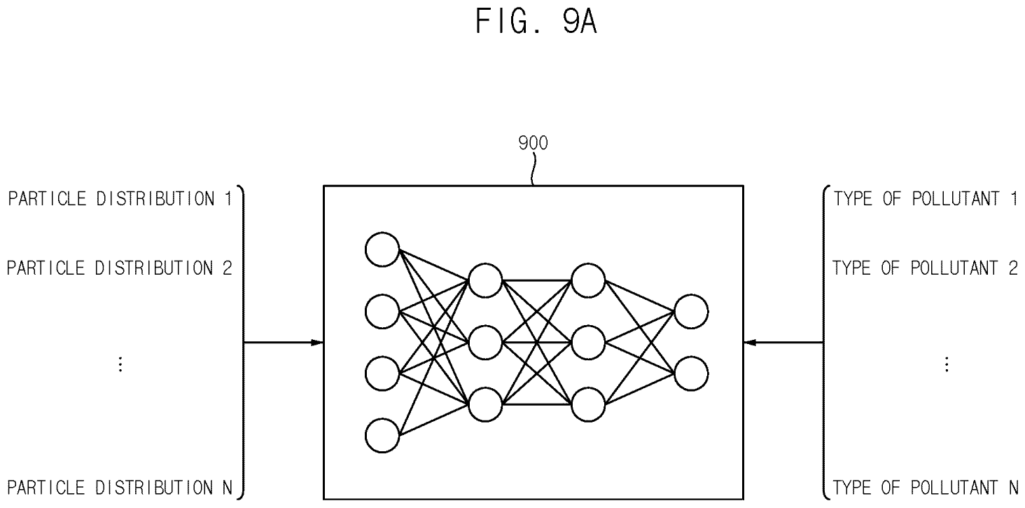

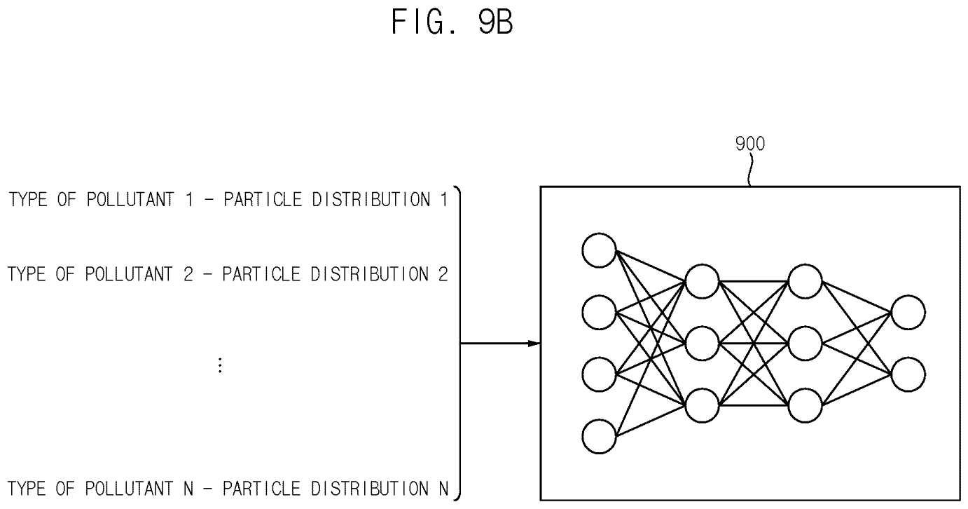

FIGS. 9A and 9B are diagrams for explaining a method of determining a type of a pollutant according to another embodiment of the present invention.

According to another embodiment of the present invention, the type of the pollutant may be determined by the artificial intelligence learning. Specifically, the type of the pollutant may be determined by the supervised learning or the unsupervised learning.

FIG. 9A shows a case of performing a supervised learning. The supervised learning derives a function from training data consisting of input value and corresponding output value. When determining the type of the pollutant by the supervised learning, the control port 160 may configure the particle distribution as input training data, configure the type of the pollutant as output training data, and perform a learning by the artificial neural network model 900 based on a pair of the input training data and the output training data.

FIG. 9B shows a case of performing an unsupervised learning. The unsupervised learning derives a function from the training data consisting of only input value without output value. When determining the type of the pollutant by the unsupervised learning, the control port 160 may perform the learning by the artificial neural network model 900 based on labeled input training data each consisting of the particle distribution and the type of the pollutant.

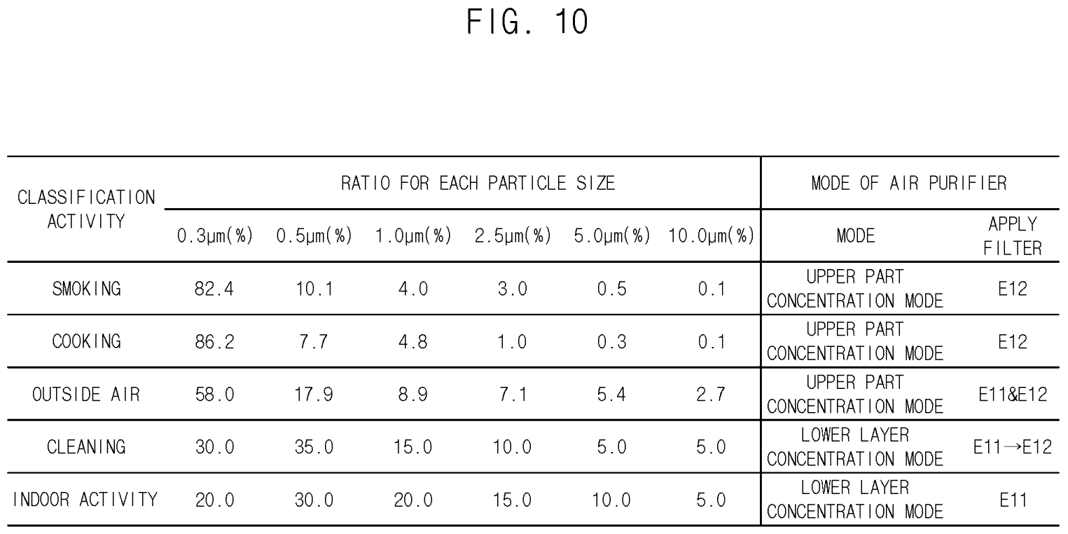

FIG. 10 is a diagram for explaining a method of controlling a mode of an air purifier according to an embodiment of the present invention.

A mode of the air purifier may be controlled according to the type of the pollutant.

Specifically, the control port 160 may determine an activity occurring in a space where the air purifier is placed based on at least one of the type of pollutant and the particle distribution, and control the mode of the air purifier corresponding to the activity.

In addition, the control port 160 may predict a predetermined area of a space where particles will be concentrated due to the activity, and control the wind direction of the air such that the discharged air is directed toward the predetermined area.

By considering both the type of the pollutant and the particle distribution, the activity occurring in the space may be determined more accurately. For example, Mosquito coil 1 and Mosquito coil 2, which are shown in FIG. 5A, have a same activity but a different particle size distribution. Therefore, by considering both the type of the pollutant and the particle distribution, the activity may be classified in more detail.

Referring to FIG. 10, in a case of the smoking and the cooking, the 0.3 μm period is 82.4% and 86.2%, respectively, and since a proportion of the small particle is more than 80%, it may be determined that the fine dust will mainly exist in an upper part of the space. Therefore, the control port 160 operates the air purifier in an upper part concentration mode and controls the wind direction to face the upper part. In addition, corresponding to this, an apply filter is operated as E12. Here, E12 is a filter optimized for a small-sized particle.

In a case of the outside air, the 0.3 μm period is 58%, the 0.5 μm period is 17.9%, and the 1.0 μm period is 8.9%, so since medium-sized particles are also mixed and present, it may be determined that the fine dust will exist in a central part of the space. Therefore, the control port 160 operates the air purifier in a central concentration mode and controls the wind direction to face the central part. In addition, corresponding to this, the apply filter operates in both E11 and E12. Here, E11 is a filter optimized for a medium-sized particle.

In a case of the cleaning, the 0.3 μm section is 30%, while the 0.5 μm section is 35%, the 1.0 μm section is 15%, and the 2.5 μm section is 10%, so since the proportion of relatively large particles is high, it may be determined that the amount of dust settled in the space is large. Therefore, the control port 160 operates the air purifier in the lower layer concentration mode and controls the wind direction to face the lower layer. In addition, in response to this, the applied filter is operated as E11 and then sequentially operated as E12.

In a case of indoor activities, the 0.5 μm period is 30%, the 1.0 μm period is 20%, and the 2.5 μm period is 15%, so since a proportion of relatively large particle is high, it may be determined that an amount of the dust settled in the space will be large. Therefore, the control port 160 operates the air purifier in a lower layer concentration mode and controls the wind direction to face the lower layer. In addition, corresponding to this, the applied filter is operated as E11. Since the proportion of the small-sized particle is relatively low, the E12 filter is not operated.

According to the embodiment, an air purification strategy may be provided in a differentiated manner according to the type of the pollutant. For example, there may be cases where the fine dust with small particle size exists mainly in the upper part of the space, and cases where fine dust with large particle size exists mainly in the lower part. Therefore, a discharge direction of the air may be changed to a mode which is efficient for a purification. In addition, a customized control mode may be changed according to the type of the pollutant.

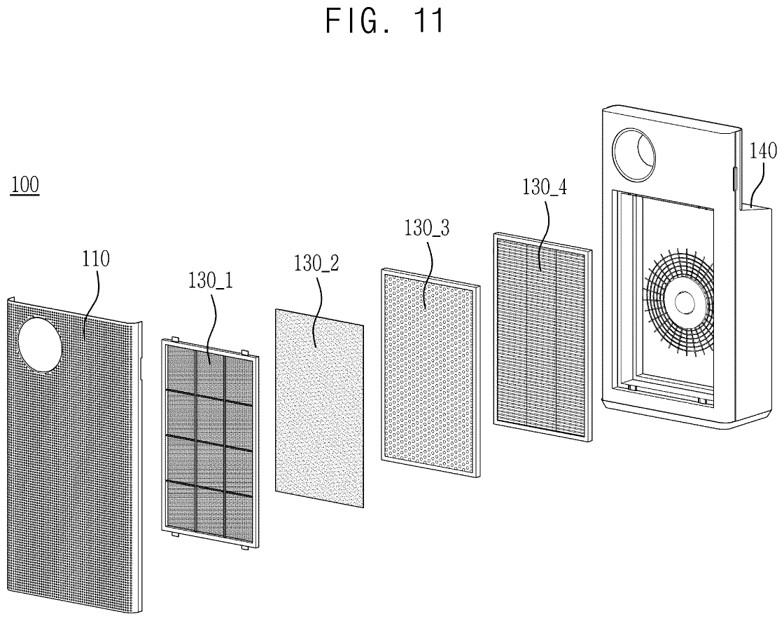

FIG. 11 is a diagram showing a detailed configuration of a filter assembly included in an air purifier according to the present invention.

The filter assembly 130 may filter the air introduced into the air purifier 100 through the inlet port 110, and may be configured to include a plurality of filters which perform corresponding to each of a plurality of filtering functions.

As shown in FIG. 11, the plurality of filters may include a superfine prefilter 130_1, an air matching filter 130_2, a deodorizing filter 130_3, and an ultrafine dust collection filter 130_4.

The superfine prefilter 130_1 may filter large particles. For example, the superfine prefilter 130_1 may filter large dust, hair, pet hair, etc.

The air-matching filter 130_2 may be selected according to a fine dust or deodorizing needs.

The deodorizing filter 130_3 may filter various household odors and five major harmful gases (ex: formaldehyde, toluene, ammonia, acetic acid, acetaldehyde).

The ultrafine dust collection filter 130_4 may remove up to 99.999% of ultrafine dust of 0.01 μm or less.

In this case, at least one filtering function to be processed is selected from among the plurality of filtering functions corresponding to at least one of the type of the pollutant and the particle distribution, and the plurality of filters 130_1, 130_2, 130_3, 130_4 may be selectively operated or the recommendation filter information may be generated corresponding to at least one filtering function. In addition, the plurality of filters 130_1, 130_2, 130_3, 130_4 may be independently disposed in different areas such that the filtering functions are spatially separated, or may be hierarchically disposed in a same area such that the filtering functions are temporally separated.

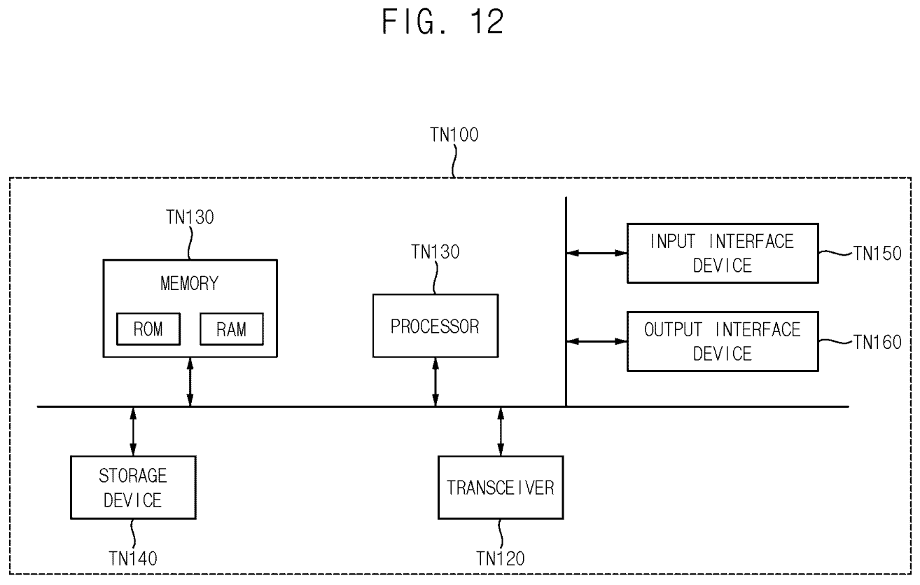

FIG. 12 is a diagram showing a computing device according to an embodiment of the present invention.

A computing device TN100 of FIG. 12 may be the air purifier 100 described in this specification.

In an embodiment of FIG. 12, the computing device TN100 may include at least one processor TN110, a transceiver TN120, and a memory TN130. In addition, the computing device TN100 may further include a storage device TN140, an input interface device TN150, an output interface device TN160, etc. Components included in the computing device TN100 may be connected by a bus TN170 to communicate with each other.

The processor TN110 may execute a program command stored in at least one of the memory TN130 and the storage device TN140. The processor TN110 may mean a central processing unit (CPU), a graphics processing unit (GPU), or a dedicated processor on which methods according to an embodiment of the present invention are performed. The processor TN110 may be configured to implement procedures, functions, and methods described in connection with an embodiment of the present invention. The processor TN110 may control each component of the computing device TN100.

Each of the memory TN130 and the storage device TN140 may store various information related to an operation of the processor TN110. Each of the memory TN130 and the storage device TN140 may be configured with at least one of a volatile storage medium and a nonvolatile storage medium. For example, the memory TN130 may be configured with at least one of a read-only memory (ROM) and a random access memory (RAM).

The transceiver TN120 may transmit or receive a wired signal or a wireless signal. The transceiver TN120 may be connected to a network and perform communication.

Meanwhile, an embodiment of the present invention is not implemented only through the device and/or method described so far, and may be implemented through a program which realizes a function corresponding to a configuration of the embodiment of the present invention or a recording medium on which the program is recorded, and such implementation may be easily implemented by a person skilled in an art in the technical field to which the present invention belongs from a description of the embodiment described above.

Although the embodiment of the present invention has been described in detail above, a scope of a right of the present invention is not limited thereto, and various modifications and improvements made by the person skilled in the art using a basic concept of the present invention defined in following claims also fall within the scope of the right of the present invention.

What is claimed is:

1. An air purifier comprising:
an intake port through which air is drawn in;
a fan unit configured to provide a blowing force to allow the air to flow;
a filter assembly configured to filter the air drawn in through the air intake port;
an outlet port through which the air passing through the filter assembly is discharged;
a dust sensor measuring a number concentration of a dust existing outside; and
a controller configured to determine a particle distribution according to a dust particle size based on the number concentration and determining the type of a pollutant corresponding to the particle distribution.

2. The air purifier of claim 1, wherein the controller,
comprises the particle distribution with a plurality of periods set corresponding to the dust particle size and a dust particle ratio included in each of the plurality of periods, and
is configured to calculate a difference value between the dust particle ratio and a preset reference ratio for each pollutant for each of the plurality of periods and to determine a similarity based on a calculation value which is a sum of the difference value, to determine a type of the pollutant.

3. The air purifier of claim 2, wherein the controller,
is configured to give a weight to the difference value in at least one period among the plurality of periods.

4. The air purifier of claim 3, wherein the controller is configured to give the weight differently to the difference value for each of the plurality of periods, and
wherein the weight in a period, where the dust particle size is a smallest, is a largest.

5. The air purifier of claim 3, wherein the controller
is configured to determine a first-priority pollutant and a second-priority pollutant in an order of decreasing the calculation value,
to determine the first-priority pollutant as the type of the pollutant when a difference between the first-priority pollutant and the second-priority pollutant is greater than or equal to a threshold value,
to give the weight differently to the difference value for each of the plurality of periods when the difference between the first-priority pollutant and the second-priority pollutant is less than the threshold value, and to increase the weight as the dust particle size is small.

6. The air purifier of claim 1, wherein the controller is configured to configure the particle distribution as input training data, to configure the type of the pollutant as output training data, and to perform machine learning using an artificial neural network model based on a pair of the input training data and the output training data.

7. The air purifier of claim 1, wherein the controller is configured to perform machine learning using an artificial neural network model based on labeled input training data consisting of the particle distribution and the type of the pollutant, respectively.

8. The air purifier of claim 1, wherein the controller is configured to determine a discharge intensity of the air corresponding to at least one of the type of the pollutant and the particle distribution, and to control an operation of the fan unit corresponding to the discharge intensity.

9. The air purifier of claim 1, wherein the outlet port is configured to adjust a discharge angle of the air, and
wherein the controller is configured to determine the discharge angle corresponding to at least one of the type of the pollutant and the particle distribution, and to control the outlet port corresponding to the discharge angle.

10. The air purifier of claim 1, wherein the filter assembly includes a plurality of filters which perform each of a plurality of filtering functions, and
the controller is configured to select at least one filtering function to be processed among the plurality of filtering functions corresponding to at least one of the type of the pollutant and the particle distribution, and to selectively operate the plurality of filters or generate recommended filter information corresponding to the at least one filtering function.

11. The air purifier of claim 1, wherein the controller is configured to determine an activity occurring in a space where the air purifier is placed based on at least one of the type of the pollutant and the particle distribution, to predict a predetermined area of the space where particles will be concentrated due to the activity, and to control a wind direction of the air such that the discharged air is directed toward the predetermined area.

12. The air purifier of claim 1, wherein the controller is configured to adjust a measurement cycle of the dust sensor corresponding to at least one of the type of the pollutant and the particle distribution.

13. A method of operating an air purifier comprising:
measuring a number concentration of a dust existing outside by a dust sensor;
determining a particle distribution according to a dust particle size based on the number concentration;
determining a type of a pollutant corresponding to the particle distribution;
filtering an air, which is drawn from outside, corresponding to the type of the pollutant by a filter assembly; and
discharging the air passing through the filter assembly to the outside through an outlet port.

14. The method of claim 13, wherein the particle distribution is composed of a plurality of periods set corresponding to the dust particle size and a dust particle ratio included in each of the plurality of periods, and
a difference value between the dust particle ratio and a preset reference ratio for each preset pollutant for each of the plurality of periods is calculated, and a similarity is determined based on a calculation value which is a sum of the difference value, such that the type of the pollutant is determined.

15. The method of claim 14, wherein a weight is given to the difference value in at least one period among the plurality of periods.

16. The method of claim 15, wherein the weight is given differently to the difference value for each of the plurality of periods, and
wherein the weight in a period, where the dust particle size is a smallest, is a largest.

17. The method of claim 15, wherein a first-priority pollutant and a second-priority pollutant are determined in an order of decreasing the calculation value,
the first-priority pollutant is determined as the type of the pollutant when a difference between the first-priority pollutant and the second-priority pollutant is greater than or equal to a threshold value,
the weight is given differently to the difference value for each of the plurality of periods when the difference between the first-priority pollutant and the second-priority pollutant is less than the threshold value, and the weight is increased as the dust particle size is small.

18. The method of claim 13, wherein the particle distribution is configured as input training data, the type of the pollutant is configured as output training data, and a learning is performed by an artificial neural network model based on a pair of the training data and the output training data.

19. The method of claim 13, wherein a learning is performed by an artificial neural network model based on labeled input training data consisting of the particle distribution and the type of the pollutant, respectively.

20. The method of claim 13, wherein based on at least one of the type of the pollutant and the particle distribution, an activity occurring in a space where the air purifier is placed is determined, a predetermined area of the space where particles will be concentrated due to the activity is predicted, and a wind direction of the air is controlled such that the discharged air is directed toward the predetermined area.

21. The method of claim 13, wherein a measurement cycle of the dust sensor corresponding to at least one of the type of the pollutant and the particle distribution is adjusted.
